(19) United States
(12) Patent Application Publication
(10) Pub. No.: US 2019/0321924 A1
(43) Pub. Date: Oct. 24, 2019

(54) CLAMP FIXTURE FOR ASSEMBLING A FOLDABLE CHAIR

(71) Applicant: SPEC SEATS TECHNOLOGIES INC., Chung-Li City (TW)

(72) Inventor: Mei Chuen LIN, Chung-Li City (TW)

(73) Assignee: SPEC SEATS TECHNOLOGIES INC., Chung-Li City (TW)

(21) Appl. No.: 15/957,430

(22) Filed: Apr. 19, 2018

(51) Int. Cl. B23K 37/04; B25B 11/02

(52) U.S. Cl. CPC B23K 37/0443; B25B 11/02

(57) ABSTRACT

A clamp fixture for assembling a foldable chair includes: a chair frame unit and a backrest which is fixed on the chair frame unit by a backrest positioning unit and welded via manual labor and/or computer controlled robot; a transverse rod is later welded on the chair frame unit by a seat-rod positioning unit and simultaneously a rear leg frame is retained in a fixed position by a seat-leg positioning unit via welding and the rear leg frame is attached to the chair frame unit in order to shorten the welding time and reducing the error due to unstable position of the chair frame unit during the welding process.

### BACKGROUND OF THE INVENTION

The present invention relates generally to a fixing device, and more particularly to a clamp fixture for fixing chair components of a foldable chair in a secure position such that the foldable chair can be assembled by means of welding.

### BACKGROUND ART DISCUSSION

Chairs are indispensable in our daily life since we sit and/or rest on them at homes or offices. To be more specific, a foldable chair is preferred to a traditional bench since the former can be folded to economize the storage space. Hence, in an assembly hall or a baseball stadium, pluralities of foldable chairs are arranged in rows in order to permit seating of audience for watching a game or match.

During the production or construction of a foldable chair, welding means is generally applied for fixing the different parts. It is hard to determine the welding point or dimension through naked eyes of a welder. The size of the welding method judged by the naked eye is difficult to guarantee fine quality of chairs, but may create major defects in the chair. Sometimes the foldable chair assembled and fixed as stated above may be unstable, and the user is liable to fall down, thereby resulting in injuries to the user and causing long time of welding processes.

In order to ensure fine quality and improve the welding efficiency, it is necessary to design a special clamp fixture for fixing chair components of a foldable chair, where positions of chair components are firstly secured, after which a welding process is conducted among the components, thereby ensuring the dimensional accuracy of the foldable chair after the welding process.

### SUMMARY OF THE INVENTION

A primary objective of the present invention is to provide a clamp fixture for assembling a foldable chair, in particular to a clamp fixture for fixing several chair components securely and stably during the welding process so as to produce a foldable chair of superior quality.

A clamp fixture of the present invention for clamping several chair components securely and stably during the welding process, includes: a backrest positioning unit disposed on a first working platform, including at least three first pressing devices, a plurality of first positioning blocks mounted on a middle portion of the first working platform, four seat-leg supporting devices and two first latch positioning devices mounted on two lateral sides of the first working platform; a seat-rod positioning unit disposed on a second working platform, including two second pressing devices, two second latch positioning devices, a plurality of second positioning blocks mounted on two lateral sides of the second working platform and a first beam pressing device mounted a middle portion of the second working platform; and a seat-leg positioning unit disposed on a third working platform, including two third positioning blocks mounted on two opposite ends of the third working platform, at least two second beam pressing devices and two second beam positioning blocks disposed on a middle portion of the third working platform, two third latch positioning devices, one of which is mounted an upper portion of the third working platform and the other one of which is mounted on a lateral side of the third working platform, and a first pusher device mounted on a lateral side of the working platform.

For production of a foldable chair, an assembler can retain positions of several chair components precisely by means of latch positioning devices of different positioning units and are secured at their appropriate positions through the pressing devices, thereby reducing the error and inferior quality of the products. The welding process is conducted by different positioning units in order to shorten the required welding time.

In one embodiment of the present invention, each of the first pressing devices, the second pressing devices, the first beam pressing device and the second beam pressing devices includes a base seat, a press stem, a support rod and a pressure head block connected pivotally to the press stem and having an end portion connected pivotally to the base seat, the press stem having an end portion connected pivotally to one end of the support rod while the other end of the support rod is connected pivotally to the base seat.

In one embodiment of the present invention, each of the first latch positioning devices, the seat-leg supporting devices, the second latch positioning devices, the first pusher device and the third latch positioning devices includes a compress stem, a latch seat, a connection rod and a retractable rod, wherein the retractable rod is connected pivotally one end of the connection rod while the other end of the connection rod is connected pivotally to the compress stem and an end portion offset from the two ends is connected pivotally on the latch seat.

In one embodiment of the present invention, each of the third positioning blocks is rectangular, has an upper surface provided with two pairs of retention pins at opposite ends thereof.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view of a backrest position unit of a clamp fixture according to a first embodiment of the present invention for clamping several chair components securely and stably during the welding process so as to produce a foldable chair;

FIG. 2 is a perspective view of a seat-rod position unit of the clamp fixture according to the first embodiment of the present invention for clamping several chair components securely and stably during the welding process so as to produce the foldable chair;

FIG. 3 is a perspective view of a seat-leg position unit of the clamp fixture according to the first embodiment of the present invention for clamping several chair components securely and stably during the welding process so as to produce the foldable chair;

FIG. 4 illustrates how a chair frame unit is retained and positioned by the backrest position unit of the clamp fixture according to the first embodiment of the present invention;

FIG. 5 illustrates how a chair frame unit is retained and positioned by the seat-rod position unit of the clamp fixture according to the first embodiment of the present invention;

FIG. 6 illustrates how a chair frame unit is retained and positioned by the seat-leg position unit of the clamp fixture according to the first embodiment of the present invention;

FIG. 7 is a perspective view of a seat-rod position unit of the clamp fixture according to a second embodiment of the present invention; and

FIG. 8 illustrates how a chair frame is retained and positioned by the seat-rod position unit of the clamp fixture according to the second embodiment of the present invention.

### DETAILED DESCRIPTION OF THE PREFERRED EMBODIMENTS

The accompanying drawings are included to provide a further understanding of the invention, and are incorporated in and constitute a part of this specification. The drawings illustrate embodiments of the invention and, together with the description, serve to explain the principles of the invention.

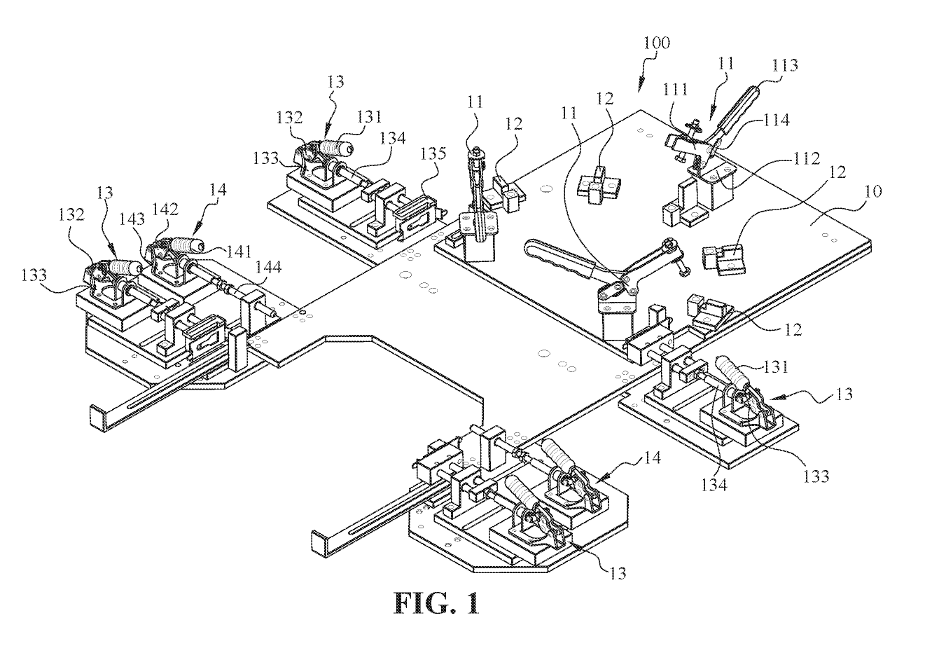

A clamp fixture of the present invention for fixing a chair frame in a secure position such that a foldable chair 60 can be assembled by means of welding. The clamp fixture of the present invention accordingly includes a backrest position unit 100, a seat-rod position unit 200 and a seat-leg position unit 300. FIG. 1 is a perspective view of a backrest position unit of a clamp fixture according to a first embodiment of the present invention for clamping several chair components securely and stably during the welding process so as to produce a foldable chair. As shown in FIG. 1, the backrest position unit 100 is disposed on a first working platform 10, includes at least three first pressing devices 11, a plurality of first positioning blocks 12 mounted on a middle portion of the first working platform 10, four seat-leg supporting devices 13 and two first latch positioning devices 14 mounted on two lateral sides of the first working platform 10. It is to note that the first working platform 10 is assembled by means of bolt-and-nut assembly such that if it is desired, the assembler can disassemble the first working platform 10 according the requirement of the circumstances. Also note that the first working platform 10 shown in FIG. 1 is assembled by using four seat-leg supporting devices 13 and two first latch positioning devices 14, and has a rectangular configuration.

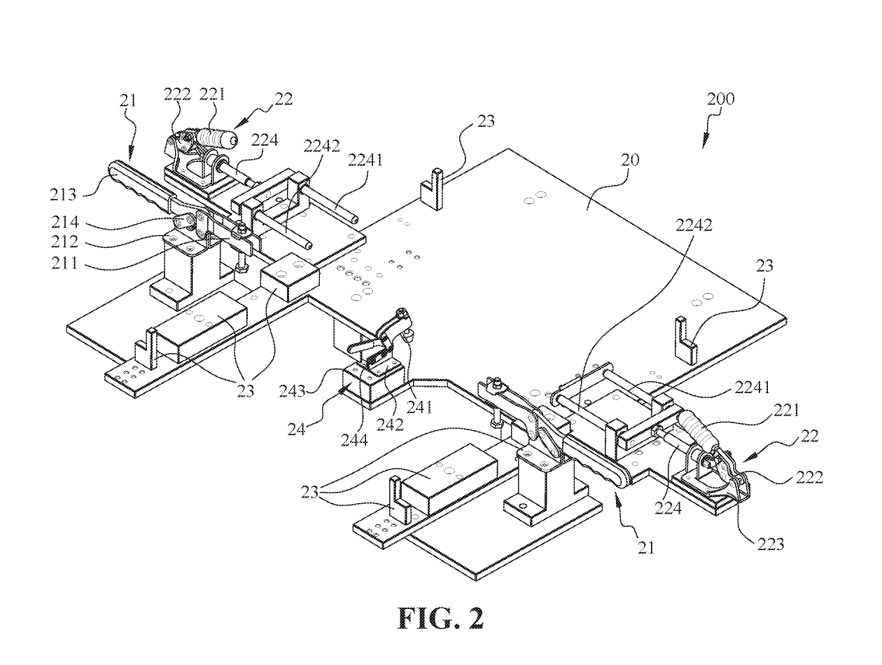

FIG. 2 is a perspective view of the seat-rod position unit of the clamp fixture according to the first embodiment of the present invention for clamping several chair components securely and stably during the welding process so as to produce the foldable chair 60. As shown in FIG. 2, the seat-rod position unit 200 is disposed on a second working platform 20, includes two second pressing devices 21, two second latch positioning devices 22, a plurality of second positioning blocks 23 mounted on two lateral sides of the second working platform 20 and a first beam pressing device 24 mounted a middle portion of the second working platform 20.

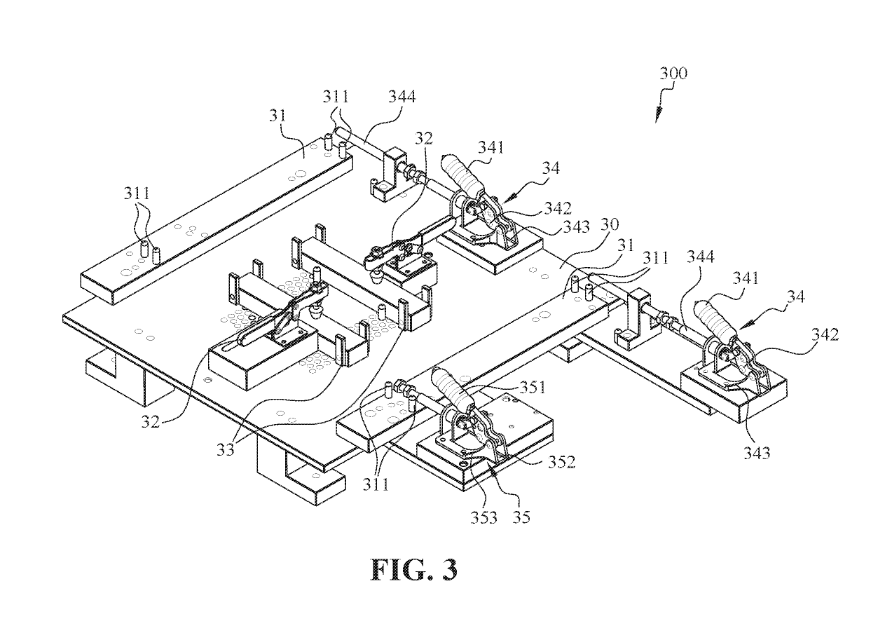

FIG. 3 is a perspective view of the seat-leg position unit of the clamp fixture according to the first embodiment of the present invention for clamping several chair components securely and stably during the welding process so as to produce the foldable chair 60. As shown in FIG. 3, the seat-leg position unit 300 is disposed on a third working platform 30, includes two third positioning blocks 31 mounted on two opposite ends of the third working platform 30, at least two second beam pressing devices 32 and two second beam positioning blocks 33 disposed on a middle portion of the third working platform 30, two third latch positioning devices 34, one of which is mounted an upper portion of the third working platform 30 and the other one of which is mounted on a lateral side of the third working platform 30, and a first pusher device 35 mounted on a lateral side of the working platform 30. Preferably, each of the third positioning blocks 31 is rectangular, has an upper surface provided with two pairs of retention pins 311 at opposite ends thereof.

In the present invention, each of the first pressing devices 11, the second pressing devices 21, the first beam pressing device 24 and the second beam pressing devices 32 includes a base seat 112, 212, 242, 322, a press stem 113, 213, 243, 323, a support rod 114, 214, 244, 324 and a pressure head block 111, 211, 241, 321 connected pivotally to the press stem 113, 213, 243, 323 and having an end portion connected pivotally to the base seat 112, 212, 242, 322, the press stem 113, 213, 243, 323 having an end portion connected pivotally to one end of the support rod 114, 214, 244, 324 while the other end of the support rod 114, 214, 244, 324 is connected pivotally to the base seat 112, 212, 242, 322 such that downward pressing by an assembler on the press stem 113, 213, 243, 323 causes downward movement of the pressure head block 111, 211, 241, 321 to compress tightly against the chair components (to be welded) owing to connection relation between the support rod 114, 214, 244, 324 and the pressure head block 111, 211, 241, 321.

One aspect of the present invention, each of the first latch positioning devices 14, the seat-leg supporting devices 13, the second latch positioning devices 22, the first pusher device 35 and the third latch positioning devices 34 includes a compress stem 131, 141, 221, 341, 351, a latch seat 133, 143, 223, 343, 353, a connection rod 132, 142, 222, 342, 352 and a retractable rod 134, 144, 224, 344, 354, wherein the retractable rod 134, 144, 224, 344, 354 is connected pivotally one end of the connection rod 132, 142, 222, 342, 352 while the other end of the connection rod 132, 142, 222, 342, 352 is connected pivotally to the compress stem 131, 141, 221, 341, 351 and an end portion offset from the two ends is connected pivotally on the latch seat 133, 143, 223, 343, 353 such that downward pressing by the assembler on the compress stem 131, 141, 221, 341, 351 causes extension of the retractable rod 134, 144, 224, 344, 354 through the holes in the chair components (to be welded) owing to connection relation between the connection rod 132, 142, 222, 342, 352 and the retractable rod 134, 144, 224, 344, 354, where the first pusher device 35 and the seat-leg supporting devices 13 retain the positions of the chair components (to be welded) stably and unmovably via the retractable rod 134, 144, 224, 344, 354.

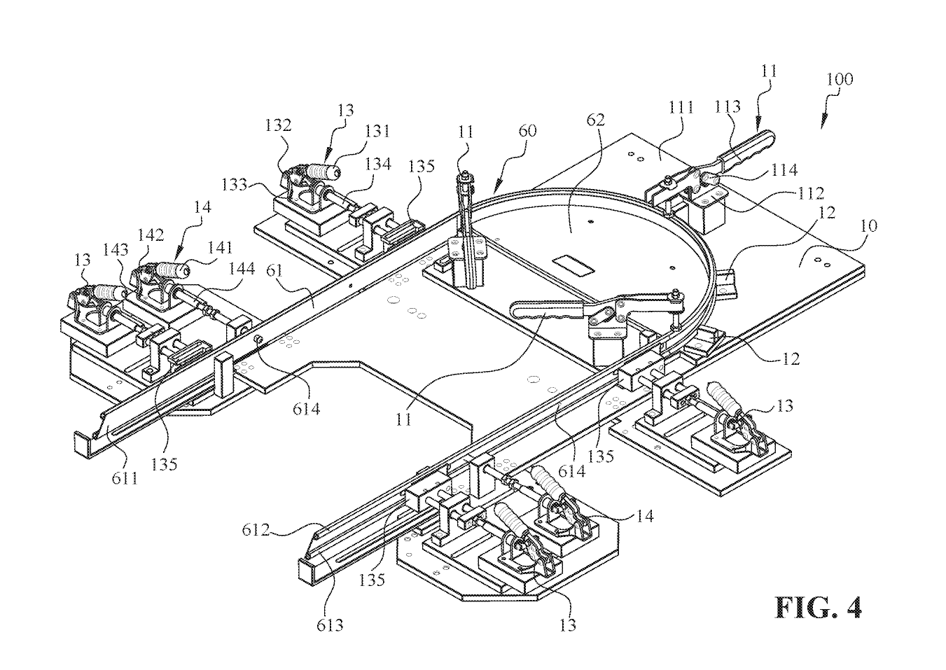

FIG. 4 illustrates how a chair frame unit is retained and positioned by the backrest position unit of the clamp fixture according to the first embodiment of the present invention. As illustrated in FIG. 4, when the assembler places an inverted U-shaped chair frame unit 61 on the first working platform 10, where two chair legs 611, 612 are spread apart from each other while the external surface of the chair frame unit 61 is formed with a retention channel 613 and a plurality of mounting bores 614. At this time, the upper curved part of the chair frame unit 61 abuts against the first positioning blocks 12 while four seat-leg supporting devices 13 and two first latch positioning devices 14 mounted on two lateral sides of the first working platform 10 are used to retain the positions of the chair legs 611, 612. Since a leg-press head 135 is installed at a free end of a respective seat-leg supporting device 13, downward pressing of the compress stem 131 of the seat-leg supporting device 13 results in movement of the retractable rod 134 toward and extends the leg-press head 135 into the retention channel 613. When the assembler presses the compress stem 141 of the first latch positioning device 14 downward causes extension of the retractable rod 144 through the bore 614 in the chair components (to be welded), thereby pressing the chair legs 611, 612 from an exterior of the chair frame unit 61. Further downward pressing of the press stem 113 of the first pressing device 11 relative to the first platform 10 finally results in retaining the chair frame unit 61 stably and securely on the first platform 10.

Once the chair frame unit 61 is fixed securely as described above, a backrest 62 to be welded is disposed above the first positioning blocks 12 mounted on the middle portion of the first working platform 10 and the welding process can be conducted via manual labor or computer controlled robot, thereby fixing the backrest on the upper curved part of the chair frame unit 61. After the preceding step, the chair frame unit 61 is removed from the first working platform 10 and is then transferred onto a second working platform 20. In this embodiment, there are four first positioning blocks 12 mounted on the middle portion of the first working platform 10, but the number of the first positioning blocks 12 should not be limited only thereto.

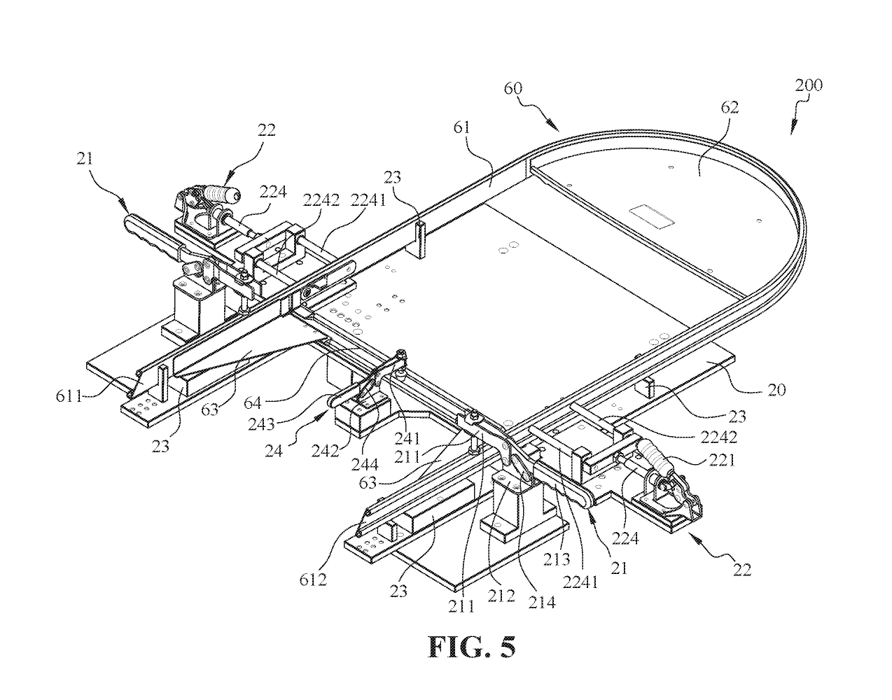

FIG. 5 illustrates how the chair frame unit 61 is retained and positioned by the seat-rod position unit of the clamp fixture according to the first embodiment of the present invention. As shown in FIG. 5, when the assembler places the inverted U-shaped chair frame unit 61 on the second positioning blocks 23 of the second working platform 20, the chair legs 611, 612 of the chair frame unit 61 are spread apart from each other and are thus retained at their appropriate positions by two second pressing devices 21 and two second latch positioning devices 22 located on two lateral sides of the second working platform 20, wherein downward pressing of the compress stem 221 of the second latch positioning device 22 results in movement of the retractable rod 224 toward and extends the positioning pins 2241 of the retractable rod 224 through the leg-press head 135 into the retention channel 613. Downward pressing by the assembler on the compress stem 141 of the first latch positioning device 14 results in extension of the retractable rod 144 through the bores 614 in the chair legs 611, 612 of the chair frame unit 61, thereby retaining the chair frame unit 61. Further downward pressing of the press stem 213 of the second pressing device 22 relative to the second platform 20 finally results in pressing of the pressure head block 211 on the chair legs 611, 612 of the chair frame unit 61, where a connection transverse rod 64 and a reinforced plate 63 are placed between the chair legs 611, 612. Then, the press stem 243 of the first beam pressing device 24 is compressed downward relative to the second working platform 20, where the pressure head block 241 abuts tightly against the connection transverse rod 64.

Once the chair frame unit 61, the connection transverse rod 64 and the reinforced plate 63 are secured as stated above, the welding process can be conducted via manual labor or computer controlled robot, thereby fixing the connection transverse rod 64 and the reinforced plate 63 to the chair frame unit 61. In this embodiment, two positioning pins 2241 are mounted at the free ends of the retractable rods 224 such that the positioning pins 2241 extend through the bore 614 in the chair frame unit 61, which further enhance retention of the chair frame unit 61 on the second working platform 20. The number of the positioning pins 2241 at the free ends of the retractable rod 224 should not be limited only thereto.

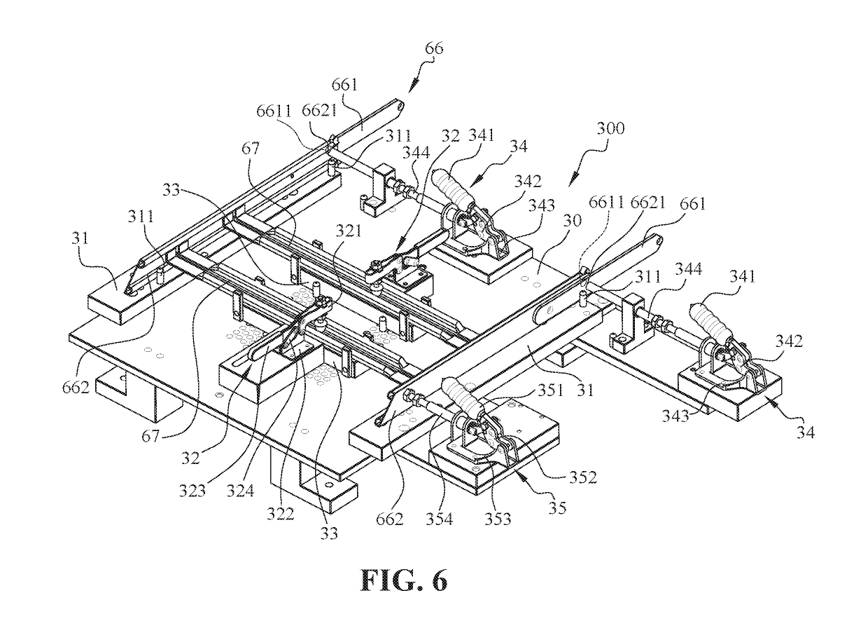

FIG. 6 illustrates how a rear leg frame 66 is retained and positioned by the seat-leg position unit 300 of the clamp fixture according to the first embodiment of the present invention. As shown in FIG. 6, after the rear leg frame 66 is placed on a third working platform 30, an upper leg frame 661 and a lower leg frame 662 are disposed on a respective third positioning block 31, where the upper and lower leg frames 661, 662 are retained thereon via two third latch positioning devices 34 and a first pusher device 35 mounted on a lateral side of the third working platform 30. After the assembler places the upper and lower leg frames 661, 662 respectively on a respective one of the rectangular third latch positioning devices 34 so as to be sandwiched between two pairs of retention pins 311 at opposite ends thereof. When the assembler presses the compress stem 341 of the third latch positioning unit 34 downward, the retractable rod 344 extends through the bores 6611, 6621 in the upper and lower leg frames 661, 662, where the compress stem 351 of the first pusher device 35 is pressed downward relative to the third working platform 30 to cause tight abutment of the retractable rod 354 against the lower leg frames 662. At this time, the upper and lower leg frames 661, 662 extends in a straight line such that two rear leg transverse rods 67 are disposed on the second beam positioning blocks 33 between the upper and lower leg frames 661, 662. Then, the press stem 323 is pressed downward to result in pressing of the pressure head block 321 on the rear leg transverse rods 67, thereby fixedly securing the rear leg frame 66 on the third working platform 30.

The welding process can be conducted manually or via computer controlled robot for connecting the bores 6611, 6621 to the rear leg transverse rods 67. Then after, the rear leg frame 66 is attached to the chair frame unit 61 in order to form the foldable chair 60. The attaching methods between the rear leg frame 66 and the chair frame unit 61 should not be limited only to the bolt-and-nut assembly, many other methods can be included so long as the objective can be achieved.

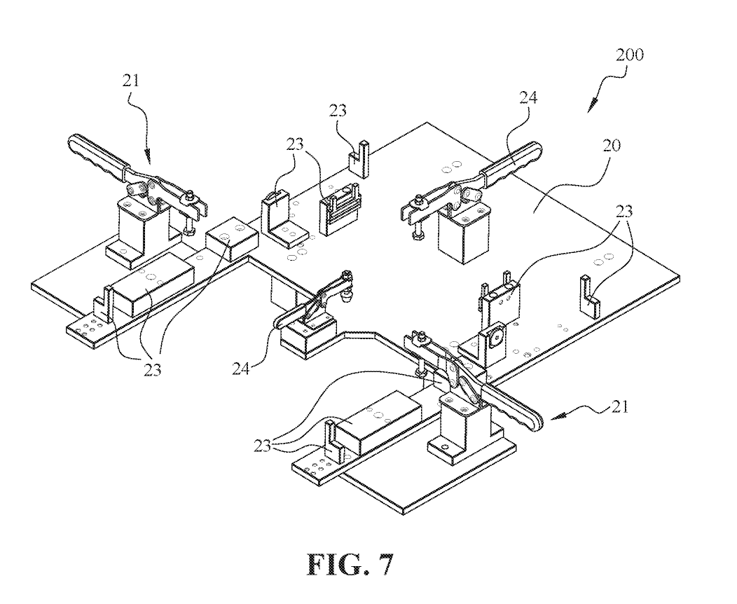

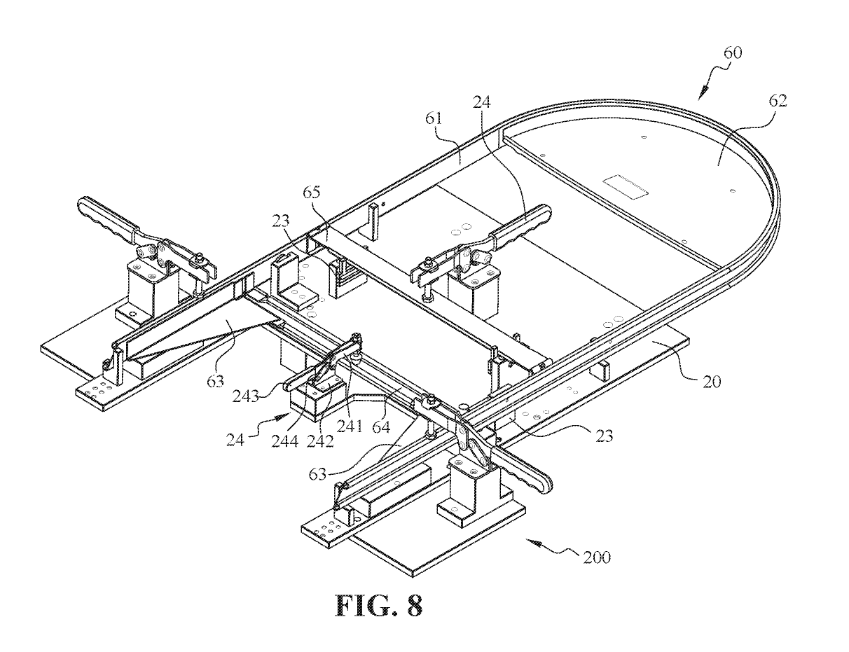

Referring to FIGS. 7 and 8, wherein FIG. 7 is a perspective view of a seat-rod position unit of the clamp fixture according to a second embodiment of the present invention; and FIG. 8 illustrates how a chair frame unit is retained and positioned by the seat-rod position unit of the clamp fixture according to the second embodiment of the present invention. Note that if the assembler desires to add an extra transverse rod 65 to the chair frame unit 61, all he needs to do is mounting at least two second beam pressing devices 24 on the second working platform 20, after which the extra transverse rod 65 can be placed on the second positioning blocks 23. Downward pressing of the press stem 243 may cause downward movement of the pressure head block 241 to compress tightly against the transverse rod 65 owing to connection relation between the support rod 214 and the pressure head block 241. The welding process can now be conducted as in the previous manner.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A clamp fixture for assembling a foldable chair, comprising:
a backrest position unit disposed on a first working platform, including at least three first pressing devices, a plurality of first positioning blocks mounted on a middle portion of said first working platform, four seat-leg supporting devices and two first latch positioning devices mounted on two lateral sides of said first working platform;
a seat-rod position unit disposed on a second working platform, including two second pressing devices, two second latch positioning devices, a plurality of second positioning blocks mounted on two lateral sides of said second working platform and a first beam pressing device mounted a middle portion of said second working platform; and
a seat-leg position unit disposed on a third working platform, including two third positioning blocks mounted on two opposite ends of said third working platform, at least two second beam pressing devices and two second beam positioning blocks disposed on a middle portion of said third working platform, two third latch positioning devices, one of which is mounted an upper portion of said third working platform and the other one of which is mounted on a lateral side of said third working platform, and a first pusher device mounted on a lateral side of said working platform.

2. The clamp fixture according to claim 1, wherein each of said first pressing devices, said second pressing devices, said first beam pressing device and said second beam pressing devices includes a base seat, a press stem, a support rod and a pressure head block connected pivotally to said press stem and having an end portion connected pivotally to said base seat, said press stem having an end portion connected pivotally to one end of said support rod while the other end of said support rod is connected pivotally to said base seat.

3. The clamp fixture according to claim 1, wherein each of said first latch positioning devices, said seat-leg supporting devices, said second latch positioning devices, said first pusher device and said third latch positioning devices includes a compress stem, a latch seat, a connection rod and a retractable rod, wherein said retractable rod is connected pivotally one end of said connection rod while the other end of said connection rod is connected pivotally to said compress stem and an end portion offset from said two ends is connected pivotally on said latch seat.

4. The clamp fixture according to claim 1, wherein each of said third positioning blocks is rectangular, and has an upper surface provided with two pairs of retention pins at opposite ends thereof.
